(19) United States
(12) Patent Application Publication
(10) Pub. No.: US 2024/0028807 A1
(43) Pub. Date: Jan. 25, 2024

(54) ONLINE INTEGRATED MICROCONTROLLER DEVELOPMENT TOOL SYSTEM, METHOD FOR IMPLEMENTING THE SAME, AND MICROCONTROLLER DEVELOPMENT COMBINATION KIT

(71) Applicant: NUVOTON TECHNOLOGY CORPORATION, HSINCHU CITY (TW)

(72) Inventors: CHIEH-SHENG TU, HSINCHU CITY (TW); TA-CHIN CHIU, HSINCHU CITY (TW); CHUN-MING HUANG, HSINCHU CITY (TW); JEN-CHIH LIU, HSINCHU CITY (TW)

(21) Appl. No.: 18/152,397

(22) Filed: Jan. 10, 2023

(30) Foreign Application Priority Data
Jul. 20, 2022 (TW) 111127256

(51) Int. Cl. G06F 30/367; G06F 30/31; G06F 30/33

(52) U.S. Cl. CPC G06F 30/367; G06F 30/31; G06F 30/33

(57) ABSTRACT

An embodiment of the present disclosure provides an online integrated microcontroller development tool system. Through the present disclosure, a microcontroller block of a suitable model number is selected according to a client requirement, pins of the microcontroller may be arranged, the microcontroller block with the arranged have been pins is connected to a functional component selected by the client, a corresponding circuit structure is generated, and based on the circuit structure, a microcontroller system hardware description code is generated and output. Different from the conventional development platform, the present disclosure helps clients to develop microcontroller application circuits for different applications through a pin required module, a functional component module and a description code project output module. Thus, purposes of simple operation and saving development time can be achieved.

### CROSS-REFERENCE TO RELATED APPLICATION

This application claims the priority from TW Patent Application No. 111127256, filed on Jul. 20, 2022, and all contents of such TW Patent Applications are included in the present disclosure.

### BACKGROUND

### 1. Field of the Invention

The present disclosure relates to a technology for developing microcontroller application circuits, in particular to, an online integrated microcontroller development tool system that assist clients in developing microcontroller application circuits of various application functions and achieve simple operation, saving development time, the method for implementing the same and a microcontroller development combination kit.

### 2. Description of the Related Art

Microcontroller (MCU) is a microcomputer. A complete microcontroller can be integrated a central processing unit (CPU), a random access memory (RAM), a read-only memory (ROM), an input/output (I/O), an analog-to-digital converter (A/D) or other functions related to memory and operation in one chip to meet the needs of different applications to do different combinations of controls. Thus, the microcontrollers have derived many uses, such as integrated circuit (IC) products for automotive electronics, smart home electronics and cloud security.

Although the application of the microcontrollers is extensive, developers of the microcontroller application circuits must understand both software and hardware knowledge. To a certain extent, it slows down the development of microcontroller application circuits. Additionally, there are too many types of system architectures and suppliers of conventional microcontroller development tools, and there is no unified development tool. Therefore, there is a need for a system that can assist program developers in developing and integrating microcontrollers, so as to save time and labor costs in developing microcontroller application circuits.

### SUMMARY

According to the purposes of the present disclosure, embodiments of the present disclosure provide an online integrated microcontroller development tool system. The online integrated microcontroller development tool system comprises a pin required module, a functional component module and a description code project output module. The pin required module is signally coupled to a database. The pin required module is configured to select a suitable model number from the database according to a pin requirement information of a client, perform a pin arrangement on a microcontroller block of the suitable model number, and output the microcontroller block with a plurality of arranged pins. The functional component module is signally coupled to the pin required module and the database. The functional component module is configured to select a functional component according to a functional component requirement information, and connect the microcontroller block with the plurality of arranged pins to the pin required module to generate a circuit structure. The description code project output module is signally coupled to the functional component module. The description code project output module is configured to output a microcontroller application circuit hardware description code based on the circuit structure.

According to the purposes of the present disclosure, embodiments of the present disclosure provide a method of implementing an online integrated microcontroller development tool, and the method comprises steps as follows. A suitable model number is selected from a database according to a pin requirement information of a client. A pin arrangement is performed on a microcontroller block corresponding to the suitable model number. The microcontroller block with a plurality of arranged pins is outputted. A functional component is selected from the database based on a functional component requirement information. Then, the microcontroller block with the plurality of arranged pins is connected to the functional component. A circuit structure is generated. A microcontroller application circuit hardware description code is outputted based on the circuit structure.

According to the purposes of the present disclosure, embodiments of the present disclosure provide a microcontroller development combination kit. The microcontroller development combination kit includes a non-transitory storage media and a development board. The non-transitory storage media is configured to make a computer device communicatively coupled to the online integrated microcontroller development tool system. As well, the non-transitory storage media is configured to execute the preceding method of the implementing the online integrated microcontroller development tool through the online integrated microcontroller development tool system.

To sum up, the embodiments of the present disclosure provide the online integrated microcontroller development tool system and a method of implementing the same. The online integrated microcontroller development tool system allows program developers to develop microcontroller application circuits according to requirements, and the online integrated microcontroller development tool system can automatically provide relevant circuit application diagrams and microcontroller application circuit hardware description codes. Also, the online integrated microcontroller development tool system can complete tests of the microcontroller application circuit hardware description codes. Therefore, the development time and development cost of the program developers are saved.

To further understand the technology, means, and effects of the present disclosure, reference may be made by the detailed description and drawing as follows. Accordingly, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a functional block diagram of an online integrated microcontroller development tool system according to an embodiment of the present disclosure;

FIG. 2 is a flowchart of a method of implementing an online integrated microcontroller development tool according to an embodiment of the present disclosure;

FIG. 3 is a schematic diagram of a first example of a pin requirement information and a functional component of a microcontroller of the online integrated microcontroller development tool system according to an embodiment of the present disclosure; and

FIG. 4 is a schematic diagram of a second example of a pin requirement information and a functional component of a microcontroller of the online integrated microcontroller development tool system according to an embodiment of the present disclosure.

### DESCRIPTION OF THE PREFERRED EMBODIMENTS

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

An embodiment of the present disclosure provides an online integrated microcontroller development tool system. The online integrated microcontroller development tool system can be configured as a platform for clients to quickly develop microcontroller application circuits. Further, the online integrated microcontroller development tool system selects a microcontroller with a suitable model number according to pin requirements of a client (or a program developer), arranges a plurality of pins for the microcontroller, and automatically provides a corresponding circuit structure. Next, the online integrated microcontroller development tool system generates a microcontroller application circuit hardware description code and a test circuit hardware description code based on the circuit structure. In addition, the online integrated microcontroller development tool system can compile the microcontroller application circuit hardware description code and the test circuit hardware description code of the microcontroller to generate a corresponding hardware description compiled code. The hardware description compiled code lets the client to perform tests on a development board. Simply speaking, the purpose of the present disclosure is to provide the online integrated microcontroller development tool system to assist the client in producing various microcontroller application circuits and testing the running state thereof.

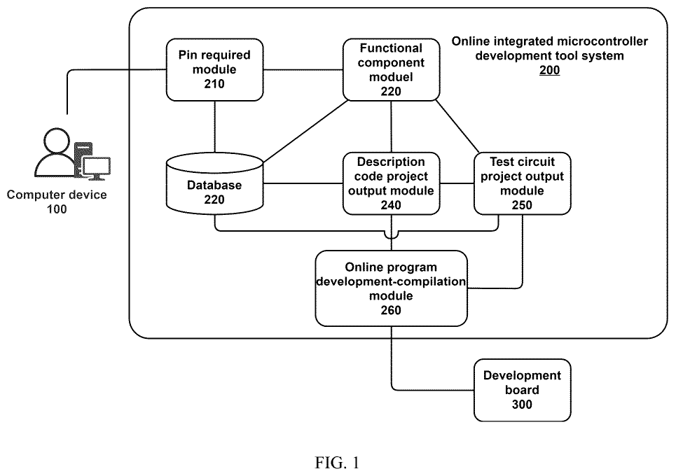

Refer to FIG. 1, which is a functional block diagram of an online integrated microcontroller development tool system according to an embodiment of the present disclosure. The online integrated microcontroller development tool system 200 includes a pin required module 210, a functional component module 230 and a description code project output module 240. The pin required module 210 is configured to select a suitable model number from a database 220 according to a pin requirement information input by a client via a computer device 100 online. Also, the pin required module 210 is configured to perform a pin arrangement on a corresponding microcontroller block of the suitable model number, and output the microcontroller block with a plurality of arranged pins. It is worth mentioning that the pin requirement information includes a pin count and a specification type of each of the pins.

The functional component module 230 is configured to select a functional component from the database according to a functional component requirement information, and the functional component module 230 is configured to make the microcontroller block with the plurality of arranged pins be connected to the functional component to generate a corresponding circuit structure. Then, the description code project output module 240 is configured to output a microcontroller application circuit hardware description code based on the circuit structure. As well, the description code project output module 240 uploads the microcontroller application circuit hardware description code to the database 220. Moreover, the circuit structure includes an application circuit structure of the microcontroller and an application circuit structure of the functional component. The above actions are all completed online by the client. In this way, a development platform that provides diversified microcontroller application circuits can be achieved, and the development efficiency can be improved.

Further, an embodiment of the present disclosure provides a test circuit project output module 250 and an online program development-compilation module 260. The test circuit project output module 250 is configured to form and output a test circuit hardware description code, and to upload the test circuit hardware description code to the database 220. The online program development-compilation module 260 is configured to compile the microcontroller application circuit hardware description code and the test circuit hardware description code to generate a hardware description compiled code. Also, the program development-compilation module 260 provides the client with the hardware description compiled code to download to a development board 300 for testing.

According to another embodiment of the present disclosure, the description code project output module 240 further outputs an application programming interface (API), a driver or a third-party code library to the computer device 100 which is connected to the development board 300. Also, the description code project output module 240 further outputs a circuit application diagram of the functional component and the microcontroller to the client.

By the way, the pin requirement information further includes a functional requirement, an operating voltage, an operating frequency, a digital-to-analog conversion resolution, a bit rate, a core type, a power consumption, a minimum operating temperature, a maximum temperature or a combination thereof for each pin.

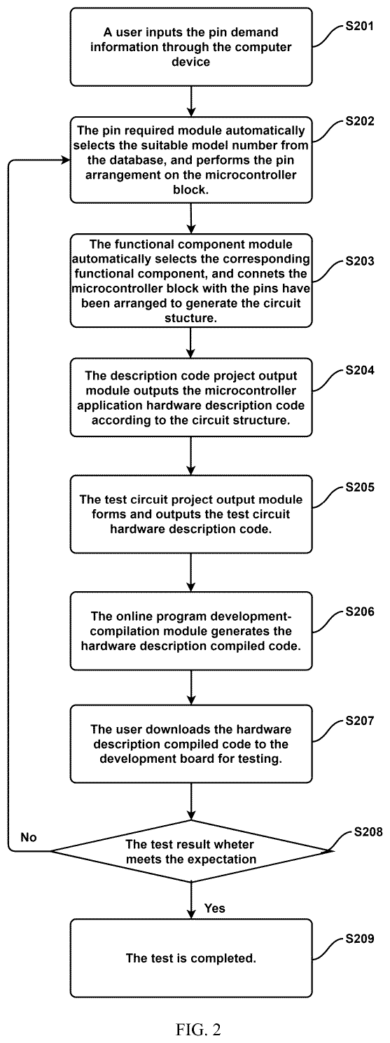

Another purpose of the present disclosure is to provide a method of implementing an online integrated microcontroller development tool. The method is implemented through the online integrated microcontroller development tool system 200. Refer to FIG. 2, which is a flowchart of a method of implementing an online integrated microcontroller development tool according to an embodiment of the present disclosure. In step S201, the client logins the online integrated microcontroller development tool system 200 via the computer device 100, and the client inputs the pin requirement information. Next, in step S202, the pin required module 210 selects the suitable model number from the database 220 according to the pin requirement information. The pin required module 210 automatically performs the pin arrangement on the microcontroller block of the suitable model number according to the pin requirement information.

Further, proceeding to step S203, the functional component module 230 selects the corresponding functional component from the database 220 according to functional component requirement information. The functional component module 230 connects the microcontroller block with arranged pins to the functional component to generate the circuit structure. Then, in step S204, the description code project output module 240 outputs the microcontroller application circuit hardware description code based on the circuit structure.

Furthermore, in step S205, the test circuit project output module 250 forms and outputs the test circuit hardware description code. In step S206, the online program development-compilation module 260 compiles the microcontroller application circuit hardware description code and the test circuit hardware description code to generate the hardware description compiled code. Next, in step S207, the hardware description compiled code is provided for the client to download to the development board 300 for testing. The test mainly focuses on testing the power consumption, performance and area of the microcontroller.

Then, proceeding to step S208, when a test result does not meet the client's expectation, for example, the circuits are too close, there is too much noise or the level of the selected microcontroller does not meet the client's needs, etc., go back to step S202. In step S202, the pin required module 210 re-selects the suitable model number, and re-arrange the pins on the microcontroller block. When the test result meets the client's expectation, the process enters to S209, the test is completed.

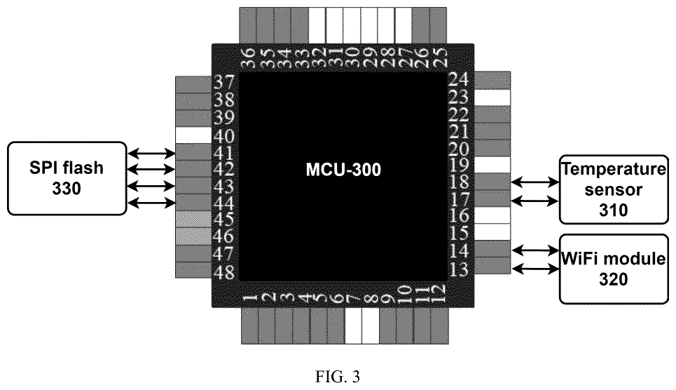

Taking a first example for further explanation, refer to FIG. 3, which is a schematic diagram of a first example of a pin requirement information and a functional component of the online integrated microcontroller development tool system according to an embodiment of the present disclosure. A client wants to make a microcontroller for a temperature sensor, and data of the temperature sensor can transmit to the computer device 100 (such as a computer or a mobile phone, etc.) via Wireless fidelity (WiFi). Hence, as shown in Table 1 below, the client selects a flash memory 128 Kb in the online integrated microcontroller development tool system 200 according to the requirements. The client inputs the pin requirement information, that is, requiring a serial peripheral interface bus (SPI) pin, a universal asynchronous receive/transmitter (UART) pin, a serial communication bus (such as an inter-integrated circuit (I²C)) pin, and so on.

Next, after the pin required module 210 receives the mentioned pin requirement information, the pin required module 210 selects a suitable model number (eg, MCU-300, but the present disclosure is not limited to this model number) from the database. Also, the pin required module 210 automatically arranges the pins on the microcontroller block corresponding to the suitable model number (MCU-300). The functional component module 230 selects the corresponding functional components, such as a temperature sensor 310, a WiFi module 320, a serial peripheral interface flash memory 330 (SPI flash), and other functional components. Then, the functional component module 230 makes the abovementioned functional components be connected to the microcontroller block with arranged pins to generate the corresponding circuit structure.

Describing in more detail, the 13^{th} and the 14^{th} pins are connected to the WiFi module 320. The 13^{th} pin is a transmit data (TXD) pin of the UART, and the 14^{th} is a receive data (RXD) pin of the UART. The 17^{th} and the 18^{th} pins are connected to the temperature sensor 310. The 17^{th} pin is a serial clock (SCL) pin of the I²C to start or stop transmission and transmit a clock sequence, and the 18^{th} is a serial data (SDA) pin of the I²C for transmission data. The 41^{st} to 44^{th} pins are SPI pins, and the 41^{th} to 44^{th} pins are connected to SPI flash 330. The 41^{st} pin is a slave select (SS) pin of the SPI, the 42^{nd} is a serial clock (SCLK) pin of the SPI, the 43^{rd} is a master input, slave output (MISO) pin of the SPI, and the 44^{th} is master output, slave input (MOSI) pin of the SPI.

It is understood that the suitable model number (MCU-300) of the first example has other functional pins. As shown in FIG. 3, the 1^{st} to 6^{th}, 47^{th} and 48^{th} pins are analog-to-digital signal pins, which can convert an analog signal collected by the temperature sensor 310 into a digital signal.

Alternatively, the client also reserves pins for future functions to be develop. For instance, if the client wants that temperature sensor 310 has an audio function, the client can reserve the SPI pins to connect to an audio module.

TABLE 1

| | | |
|---|---|---|
| Flash | 128 | kb |
| RAM | 16 | kb |
| UART | 2 | kb |
| SPI | 1 | kb |
| ADC | 8 | kb |
| PWM | 6 | kb |
| I²C | 1 | kb |
| USB | 1 | kb |

In an embodiment of the present disclosure, a microcontroller development combination kit (not shown in figures) is also provided. The microcontroller development combination kit includes a non-transitory storage media (not shown in figures) and the mentioned development board 300. The non-transitory storage media stores a plurality of description codes. The non-transitory storage media is configured to execute the method for implementing the online integrated microcontroller development tool via the online integrated microcontroller development tool system 200.

Additionally, in an embodiment of the present disclosure, when the client connects the development board 300 online to test the microcontroller application circuit, in order to ensure that the development board 300 of the client is consistent with description codes, a driver, etc. stored in the non-transitory storage media, the codes comprise a verification program to verify the development board 300. After the development board 300 is verified, the computer device 100 is allowed to communicate with the online integrated microcontroller development tool system 200 to perform subsequent testing of the microcontroller application circuit.

However, the hardware description compiled code generated above is an idealized case. In the practical test, the test results may not meet the client's expectations, because, for example, the circuit routings are too close (may cause inductive coupling), clock of the function implementation is not synchronous, or the specification of the microcontroller do not meet the requirements, etc. Therefore, by testing, the client is able to understand whether the data output by the developed microcontroller meets the expectations, especially for the power consumption, performance (accuracy) and area test. The client can re-select the suitable model number which is more in line with the actual requirement. Then, the pin required module 210 re-arranges the pins according to the pin requirement information, and regenerate the application circuit to implement the microcontroller application circuit, or to optimize the microcontroller application circuit.

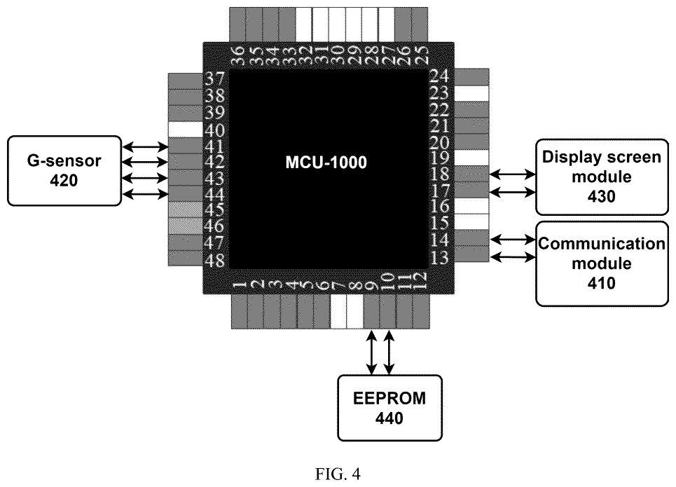

Further, taking a second example, refer to FIG. 4, which is schematic diagram of a second example of a pin requirement information and a functional component of a microcontroller of the online integrated microcontroller development tool system 200 according to an embodiment of the present disclosure. If the client wants to make a microcontroller with gravity sensing, the functions required by the client are a communication module communicated with the computer device 100 by means of WiFi or Bluetooth, a gravity sensor (G-sensor), a function of a universal serial bus (USB) for charging or transmitting data to the computer device, as well as a function to connect a display screen.

Therefore, the client selects the specification as Flash 256 Kb in the online integrated microcontroller development tool system 200. As shown in Table 2 below, the microcontroller block at least has pins such as UART pins, I²C pins, SPI pins, USB pins and so on.

TABLE 2

| | | |
|---|---|---|
| Flash | 256 | kb |
| EEPROM | 32 | kb |
| UART | 8 | kb |
| SPI | 4 | kb |
| ADC | 8 | kb |
| PWM | 6 | kb |
| I²C | 2 | kb |
| USB | 2 | kb |

As shown in FIG. 4, after the pin required module 210 confirms the pin requirement information input by the client, the pin required module 210 starts to select the suitable model number (eg, MCU-1000, but the present invention is not limited to this model number) from the database 220. Then, the pin required module 210 performs the pin arrangement on the microcontroller block of the microcontroller (MCU-1000). The functional component module 230 selects an appropriate communication module 410, a G-sensor 420, a display screen module 430, an electrically-erasable programmable read-only memory 440 (EEPROM) and other functional components, and the functional component module 230 generates the corresponding circuit structure.

As shown in FIG. 4, the 9^{th} and 10^{th} pins are the pins of the VC, and the 9^{th} and 10^{th} pins are connected to the EEPROM 440 to store all information for a certain period of time. The 13^{th} and 14^{th} pins are the UART pins, and the 13^{th} and 14^{th} pins are connected with the communication module 410 (for example, a WiFi module or a Bluetooth module). The 17^{th} and the 18^{th} pins are the VC pins, and the 17^{th} and the 18^{th} pins are connected to the display screen module 430. The 41^{st} to 44^{th} pins are the SPI pins, and the 41^{st} to 44^{th} pins are connected to the G-sensor 420. Besides, the 33^{rd} to 36^{th} pins are the USB pins which are utilized for charging and transmitting data.

Based on the above, the circuit structure is generated by the functional component module 230, and the description code project output module 240 generates the microcontroller application circuit hardware description code based on the circuit structure. Next, the test circuit project output module 250 forms and outputs the test circuit hardware description code. Then, the online program development-compilation module 260 generates the hardware description compiled code, so that the microcontroller can execute the functions of sensing the gravity and presenting the data on the display screen.

Next, the hardware description compiled code generated by the online program development-compilation module 260 can be provided to the client to download to the development board 300 for testing. The application circuit of the microcontroller (MCU-1000) can be tested after the development board 300 of the client is connected to the computer device 100 and verified successfully.

Moreover, the microcontroller (MCU-1000) may be configured in devices such as a pedometer, a dashcam, or exercise intensity detectors. Although the devices are related to the application circuits of the G-sensor, the accuracy requirements of the G-sensor for corresponding devices are different from each other. For instance, the accuracy requirement of the dashcam is higher than that of the pedometer, and the accuracy requirement is related to the data processing capability, filtering out noise and so on of the microcontroller. As a result, different accuracy of the G-sensor has different application circuit structure. Thus, after the hardware description compiled code is tested on the development board 300, it may happen that the selected suitable model number does not meet the client's expecting accuracy requirements due to the different bit requirements of the analog-to-digital converter, and the appropriate model number is re-selected.

As the stated as above, the circuit structure is an important part of developing microcontroller. As the mentioned two examples, if the circuit structure of the second example involves the amplification and filtering of the gravity signal to improve the accuracy of the gravity signal, and the hardware description compiled code must be able to control peripheral units (such as the screen display), the circuit structure involved in the second example becomes rather complicated. The online integrated microcontroller development tool system of the present disclosure can provide the clients with examples of the circuit structures, so that the clients do not need to design circuits from scratch by themselves. Moreover, the clients can modify the existing examples of the circuit structures online, so as to develop microcontrollers that meet the needs of the applications.

Furthermore, for the clients, the clients do not need to install any software, and the online platform can generate microcontrollers for different applications based on the client's own needs. Also, various circuit hardware description codes can be automatically generated, and the circuit hardware description codes can be tested with the development board. In this way, the clients can obtain related product resources simultaneously, so as to achieve the technical effects of speeding up the development process and reducing development cost. Moreover, the client's inputs and operations in the online platform are not complicated, so that a platform for diversified learning and development of microcontrollers is provided.

In addition, for developers who develop microcontrollers, because of the inputs and operations from other clients in the online integrated microcontroller development tool system, customer information and market requirements can be obtained. In this way, the embodiments of the present disclosure can provide developers with the planning direction of future products. Moreover, better digital services, more cost-effective products, etc. are provided. Therefore, the present disclosure has huge commercial value.

It should be understood that the examples and the embodiments described herein are for illustrative purpose only, and various modifications or changes in view of them will be suggested to those skilled in the art, and will be included in the spirit and scope of the application and the appendix with the scope of the claims.

What is claimed is:

1. An online integrated microcontroller development tool system, comprising:
a pin required module, signally coupled to a database, and configured to select a suitable model number of a microcontroller from the database according to a pin requirement information of a client, perform a pin arrangement on a microcontroller block corresponding to the suitable model number, and output the microcontroller block with a plurality of arranged pins;
a functional component module, signally coupled to the pin required module and the database, and configured to select a functional component corresponding to a functional component requirement information, and connect the microcontroller block with the plurality of arranged pins to the functional component to generate a circuit structure respectively; and
a description code project output module, signally coupled to the functional component module, and configured to output a microcontroller application circuit hardware description code based on the circuit structure.

2. The online integrated microcontroller development tool system according to claim 1, further comprising:
a test circuit project output module, signally coupled to the functional component module, and configured to form and output a test circuit hardware description code; and
an online program development compilation module, signally coupled to the description code project output module and the test circuit project output module, and configured to compile the microcontroller application circuit hardware description code and the test circuit hardware description code to generate a hardware description compiled code, and provide the client to download the hardware description compiled code to a development board for testing.

3. The online integrated microcontroller development tool system according to claim 2, wherein the description code project output module further outputs an application programming interface (API), a driver or a third-party code library of the functional component to a computer device connected to the development board.

4. The online integrated microcontroller development tool system according to claim 3, the description code project output module further outputs a circuit application diagram of the functional component and the microcontroller to the client.

5. The online integrated microcontroller development tool system according to claim 1, wherein the pin requirement information comprises a pin count and a specification type of each of the pins.

6. The online integrated microcontroller development tool system according to claim 5, wherein the pin requirement information further comprises a functional requirement, an operating voltage, an operating frequency, a digital-to-analog conversion resolution, a bit rate, a core type, a power consumption, a minimum operating temperature, a maximum temperature or a combination thereof.

7. A method of implementing an online integrated microcontroller development tool, comprising:
selecting a suitable model number of a microcontroller from a database according to a pin requirement information of a client;
performing a pin arrangement on a microcontroller block corresponding to the suitable model number, and outputting the microcontroller block with a plurality of arranged pins;
selecting a functional component based on a functional component requirement information from the database, connecting the microcontroller block with the plurality of pins have been arranged to the functional component, and generating a circuit structure; and
outputting a microcontroller application circuit hardware description code based on the circuit structure.

8. The method of implementing the online integrated microcontroller development tool of claim 7, further comprising:
forming and outputting a test circuit hardware description code;
compiling the microcontroller application circuit hardware description code and the test circuit hardware description code to generate a hardware description compiled code; and
providing the client with the hardware description compiled code to download to a development board for testing.

9. The method of implementing the online integrated microcontroller development tool of claim 8, further comprising:
outputting an application programming interface (API), a driver or a third-party code library of the functional component to a computer device which is connected to the development board.

10. The method of implementing the online integrated microcontroller development tool of claim 9, further comprising:
outputting a circuit application diagram of the functional component and the microcontroller to the client.

11. The method of implementing an online integrated microcontroller development tool of claim 7, wherein the pin requirement information includes a pin count and a specification type for each of the plurality of pins.

12. A microcontroller development combination kit, comprising:
a non-transitory storage media, storing a plurality of description code, and configured to communicatively couple a computer device and an online integrated microcontroller development tool system, and execute a method of implementing an online integrated microcontroller development tool through the online integrated microcontroller development tool system, and the method comprising:
selecting a suitable model number of a microcontroller from a database according to a pin requirement information of a client;
performing a pin arrangement on a microcontroller block corresponding to the suitable model number, and outputting the microcontroller block with a plurality of arranged pins;
selecting a functional component based on a functional component requirement information from the database, connecting the microcontroller block with the plurality of pins have been arranged to the functional component, and generating a circuit structure; and
outputting a microcontroller application circuit hardware description code based on the circuit structure; and
a development board.

13. The microcontroller development combination kit according to claim 12, wherein the method further comprises:
forming and outputting a test circuit hardware description code;
compiling the microcontroller application circuit hardware description code and the test circuit hardware description code to generate a hardware description compiled code; and
providing the client with the hardware description compiled code to download to a development board for testing.

14. The microcontroller development combination kit according claim 13, wherein the method further comprises:
outputting an application programming interface (API), a driver or a third-party code library of the functional component to a computer device which is connected to the development board.

15. The microcontroller development combination kit according claim 14, wherein the method further comprises:
outputting a circuit application diagram of the functional component and the microcontroller to the client.

16. The microcontroller development combination kit according claim 12, wherein the pin requirement information includes a pin count and a specification type for each of the plurality of pins.

17. The microcontroller development combination kit according claim 12, wherein the plurality of description codes of the non-transitory storage media comprises a verification program;
wherein the verification program is configured to verify the development board; and
the computer device is allowed to be communicatively coupled to the online integrated microcontroller development tool system after the development board is verified.
